(19) United States
(12) Patent Application Publication
(10) Pub. No.: US 2019/0192964 A1
(43) Pub. Date: Jun. 27, 2019

(54) RPG TECH (Roots Portable Game Technology)

(71) Applicant: Rootdrail Soirilien, Miami, FL (US)

(72) Inventor: Rootdrail Soirilien, Miami, FL (US)

(21) Appl. No.: 15/932,434

(22) Filed: Nov. 22, 2016

(51) Int. Cl. A63F 13/235; A63F 13/24; A63F 13/25; G03B 21/14; A63F 13/90

(52) U.S. Cl. CPC A63F 13/235; A63F 13/24; A63F 13/90; G03B 21/145; A63F 13/25

(57) ABSTRACT

The new game design R.P.G. is an innovative gaming console inspired by garners who imagine the future of convenient gaming. The RPG Console is designed with the idea of taking the game anywhere you go playing whenever you want. This console is a first of its kind, short throw projection video gaming console. The RPG Console features projection play modes on a portable battery-operated console, with a new flex designed control for comfortable game play. With the RPG Console, garners will enjoy virtual reality compatible play, 3D effects, blu ray movie play, onboard camera for social connection as well as facial recognition and voice command operations. The RPG Console represents the latest in futuristic gaming and designs, signaling a new age of gaming.

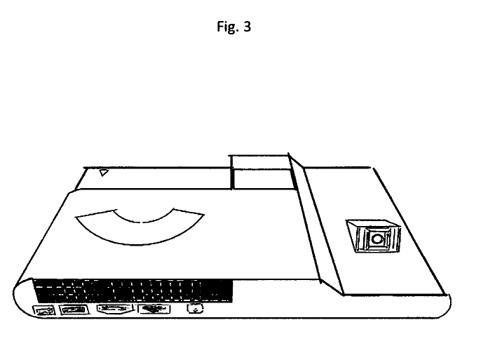

The RPG Tech is a game console equipped with High definition LED projector (FIG. 3). With the latest gamming software, internet connection, the integrated multi surface LED projector capable of displaying up to 80″ screen to any surface, a very efficient rechargeable battery able to power up to 8 hours of playtime, and a light and sleek design, it will be smart and most of all define the true meaning of portable. It is the first of it kind, and with it's multi player function, you can't go wrong with it. Whether you're at the park, at the airport terminal waiting on a delay flight or even on the woods camping, the RPG tech Will be your first source of entertainment, just tell your friends to bring their controller. And although it's a game console, it won't be only a game players' choice, but everyone's because of the Internet connection with WIFI and Bluetooth connectivity. And will be able to be used as a regular Blue ray CD/DVD player. So everyone get ready to enjoy the RPG Tech.

### FEATURES

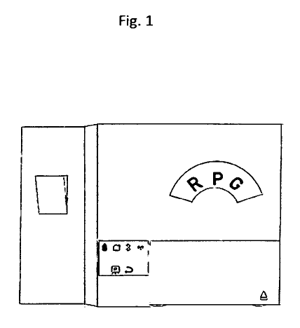

### (FIG. 1) Top of Console

On top of the console, you have the control panel, the console logo, the disk inlet, the eject button and the top of the projector.

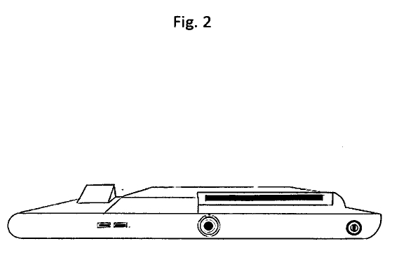

### (FIG. 2) Back of Console

On FIG. 2, you're looking at the power button, Headphone jack, USB jack for controller, and the Ac power input.

### (FIG. 3) Front of Console

On FIG. 3, you have the ventilation grille, HDMI ports, Audio outputs, Front of projector lens, battery compartment.

1. A gamming console with a central processing center (CPU),with memory and a High definition LED Projector attach to it, so there is no need to use a TV set to display the game you're playing, as shown on the specification.
A Rechargeable and removable battery, that once fully charge, the console become a mobile unit that you can take it anywhere with you as describe in the specification.
Input and output jacks enabling connection of power, speakers and game controllers
A control panel connected to the CPU and memory of the console enabling:
(1) the control of the projector
(2) charging the battery and switching power mode,
(3) enternet and bluetooth connectivity.
